(19) United States
(12) Patent Application Publication
(10) Pub. No.: US 2017/0193096 A1
(43) Pub. Date: Jul. 6, 2017

(54) AUTOMATICALLY MODIFYING A FOOD PREPARATION RECIPE BASED ON USER GENERATED SUGGESTIONS

(71) Applicant: INTERNATIONAL BUSINESS MACHINES CORPORATION, ARMONK, NY (US)

(72) Inventors: DHRUV A. BHATT, INDIAN TRAIL, NC (US); KRISTIN MCNEIL, CHARLOTTE, NC (US); NITABEN A. PATEL, CHARLOTTE, NC (US)

(73) Assignee: International Business Machines Corporation, Armonk, NY (US)

(21) Appl. No.: 15/087,221

(22) Filed: Mar. 31, 2016

Related U.S. Application Data
(63) Continuation of application No. 14/983,935, filed on Dec. 30, 2015, now abandoned.

(51) Int. Cl. G06F 17/30; G09B 19/00

(52) U.S. Cl. CPC G06F 17/30699; G06F 17/30646; G06F 17/30675; G09B 19/0092

(57) ABSTRACT

A computing device can detect user comments directed to a food preparation recipe. A suggested recipe modifications can be extracted from the comments. The modification can be quantified and a modification score based on analyzed positive and negative sentiments indicated on the Web site can be associated with the modification. The modifications can be utilized to create a filtered modification set. A computer constructed food preparation recipe can apply the modifications of the filtered modification set to the food preparation recipe. The computer constructed food preparation recipe is not created by a human but can be a novel aggregate from inputs of at three or more different humans. The computer constructed food preparation recipe can be presented on the Web site.

### CROSS-REFERENCE TO RELATED APPLICATIONS

This application is a Continuation of U.S. patent application Ser. No. 14/983,935, filed 30 Dec. 2015 (pending), which is incorporated herein in its entirety.

### BACKGROUND

The present invention relates to the field of automated content enhancement and, more particularly, to automatically modifying a food preparation recipe based on user generated suggestions.

As technology makes users lives easier, more and more users are turning to previously mundane activities as hobbies to fill their recreational time. For example, people are becoming increasingly enamored with cooking food for non-traditional reasons such as treating themselves to gourmet feasts and for entertaining guests. Many Web sites have popped up as a result of this growing trend and the market is highly competitive. Consequently, Web sites are seeking more innovative ways to provide the best recipes to users and increase user return visits.

One common mechanism which engages return users is the ability to comment on recipes. Some of these comments have useful information about how a user tried the recipe and made changes to improve the recipe. Frequently, however, many of the comments are not helpful at all. Since, it can consume a large portion of time to read and manually filter the valuable information from user's comments, users are less inclined to do so. As such, many valuable changes which could improve the recipe are frequently ignored.

### BRIEF SUMMARY

One aspect of the present invention can include a method, a system, and a computer program product for automatically modifying a food preparation recipe based on user generated suggestions. A computing device can detect a food preparation recipe which is manually created by a human and is posted on a Web site having one or more user comments directed to the food preparation recipe. Human constructed suggested recipe modifications can be extracted from the user comments on the Web site. A modification score based on analyzed positive and negative sentiments indicated on the Web site for a corresponding one of the suggested recipe modifications can be quantified. Conflicting suggested recipe modifications can be detected. The suggested recipe modifications can be filtered to create a filtered modification set. The filtering can exclude suggested recipe modifications having a modification score under a designated threshold. The filtering can exclude suggested recipe modifications in conflict and having a lower modification score than other suggested recipe modifications to which the conflict arises. A computer constructed food preparation recipe that applies all of the suggested recipe modifications of the filtered modification set to the food preparation recipe can be generated. The computer constructed food preparation recipe was not created by a human but is a novel aggregate from inputs of at least three different humans. The computer constructed food preparation recipe can be presented on the Web site.

Another aspect of the present invention can include a system, a method, and a computer program product for automatically modifying a food preparation recipe based on user generated suggestions. An engine can generate a computer constructed food preparation recipe that applies suggested recipe modifications of a filtered modification set to a food preparation recipe. The computer constructed food preparation recipe was not created by a human but is a novel aggregate from inputs of at least three different humans. The suggested recipe modifications can be obtained from the user provided comment associated with the recipe. A data store can be configured to persist the food preparation recipe, the filtered modification set, and computer constructed food preparation recipe.

### BRIEF DESCRIPTION OF THE SEVERAL VIEWS OF THE DRAWINGS

FIG. 1 is a flowchart illustrating a method for automatically modifying a food preparation recipe based on user generated suggestions in accordance with an embodiment of the inventive arrangements disclosed herein.

FIG. 2 is a schematic diagram illustrating a system for automatically modifying a food preparation recipe based on user generated suggestions in accordance with an embodiment of the inventive arrangements disclosed herein.

### DETAILED DESCRIPTION

The present disclosure is a solution for automatically modifying a food preparation recipe based on user generated suggestions. In the solution, a recipe within a Web site or repository can be identified. One or more comments associated with the recipe can be selected. The comments can be analyzed to determine one or more suggested modifications to the recipe. For example, natural language processing can be performed to determine ingredient additions and quantities for improving the recipe flavor profile. In one embodiment, a computer generated aggregate recipe can be composited together from favorable user provided suggestions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

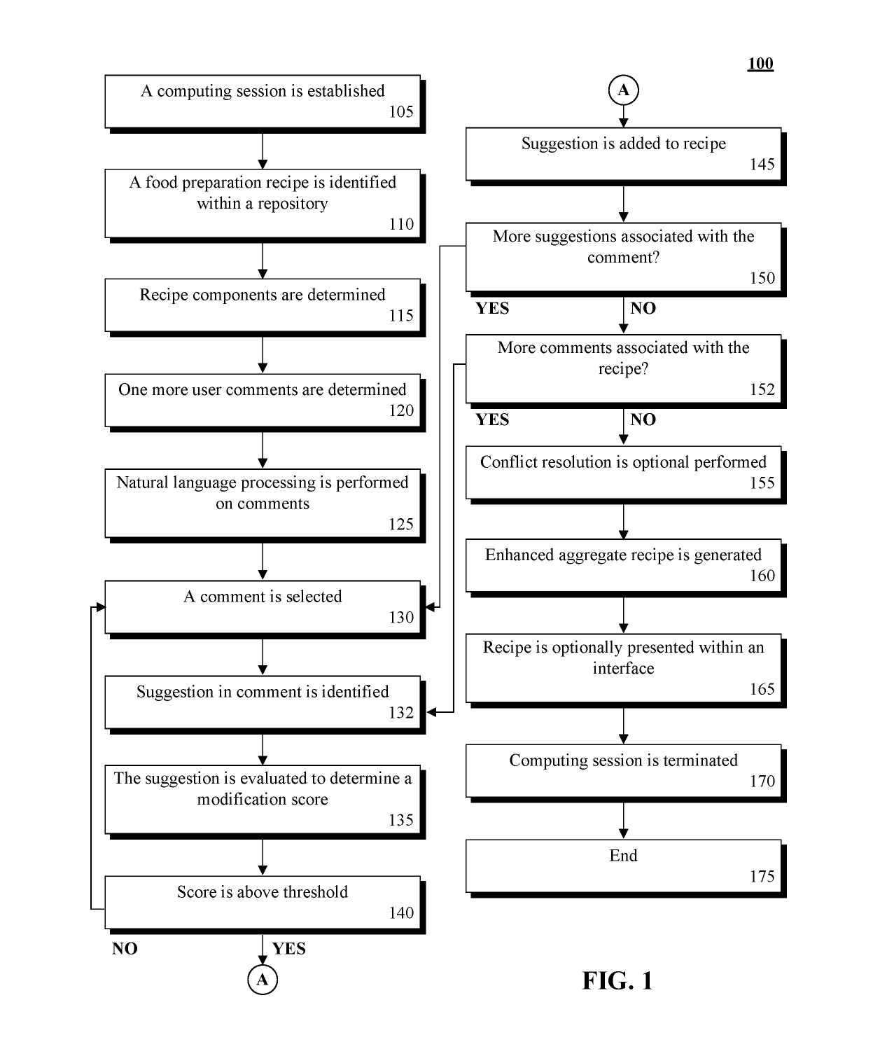

FIG. 1 is a flowchart illustrating a method 100 for automatically modifying a food preparation recipe based on user generated suggestions in accordance with an embodiment of the inventive arrangements disclosed herein. Method 100 can be performed in the context of system 200.

As used herein, a recipe can be a set of instructions that describes how to prepare a culinary dish. Recipe components can include, but is not limited to, a recipe name (and e.g., locale or provenance) of the dish, time required for preparation the dish, a required ingredients list, ingredient quantities, ingredient proportions, necessary equipment and environment for preparation of the dish, an ordered list of preparation steps and techniques, the yield, the texture and/or flavor, a photograph of the finished dish, a photograph of one or more steps (e.g., associated with ordered list), a video, and the like. In one instance, a flavor can be a sensory impression of food or other substance, and can be determined primarily by the chemical senses of taste and smell. In the instance, a flavorant can be a cooking substance that gives another substance flavor, altering the characteristics of the solute, causing it to become sweet, sour, tangy, and the like.

As used herein, comment can be a user generated content associated with a recipe. Comment can include, but is not limited to, a text, an image, a video, a sentiment, and the like. In one instance, comment can include a suggestion can conform to any natural language format, structured format, and the like. In one instance, comment can include structured formats including, but not limited to, presentational markup (e.g., bullets, indentation), descriptive markup, and the like. It should be appreciated that comment can include annotations, metadata, and the like.

In step 105, a computing session can be established. The computing session can be manually and/or automatically established. In one embodiment, session can be initiated by a persistent process thread within a computer execution environment. In step 110, a food preparation recipe can be identified within a repository. In one instance, the recipe can be identified manually and/or automatically. In one instance, the recipe can be selected randomly, by alphabetical order, by recipe identifier (e.g., ascending, descending order), by date (e.g., earliest creation date, earliest modification date), and the like. In step 115, recipe components can be determined. Components can be determined utilizing natural language processing, structured format processing (e.g., Extensible Markup Language document, RecipeML, Hypertext Markup Language), and the like. In step 1120, one or more user comments associated with the recipe can be determined. In one instance, the disclosure can determine user comments associated with a step, an ingredient component, the recipe, and the like. In step 125, natural language processing is performed on comments. In one instance, natural language processing can utilize traditional and/or proprietary lexical processing algorithm. In step 130, a comment can be selected. Comment selection can be ordered, random, and the like. In one instance, comment selection can be performed based on hierarchy (e.g., nested comments), based on sentiment, and the like. In step 132, a suggestion within the comment can be identified. Suggestion can include, but is not limited, an ingredient addition, an ingredient removal, an ingredient quantity change, and the like.

In step 135, the suggestion can be evaluated to determine a modification score associated with the suggestion. In one embodiment, a sentiment associated with the comment can be utilized to determine a modification score. In the embodiment, one or more score generation algorithms can be employed to compute score based on comment rating, comment replies, comment views, and the like. It should be appreciated that a Web site ranking associated with comment (e.g., stars, thumbs up/down) can be utilized to establish a portion of modification score. In step 140, if the score is above threshold, the method can continue to step 145, else return to step 130. In step 145, the suggestion can be added to the recipe. In one instance, the suggestion can be converted to the appropriate units and/or locale of the recipe. For example, if grams are used by the recipe, the comment for adding a ¼ tbsp can be modified to 3.75 grams. In step 150, if there are more suggestions associated with the comment, the method can return to step 130, else continue to step 152. In step 152, if there are more comments associated with the recipe, the method can return to step 132. In step 155, conflict resolution can be performed if a conflict with recipe suggestions and/or recipe components exist. In one instance, conflict resolution can be performed utilizing automatically via a ruleset, manual via one or more user actions, and the like. In one embodiment, an enhanced aggregate recipe can be generated. In step 164, the recipe can be optionally presented within an interface. For example, the recipe can be presented within a Web browser interface of a Web browser. In step 170, the computing session can be terminated. In step 175, the method can end.

Drawings presented herein are for illustrative purposes only and should not be construed to limit the invention in any regard. Method 100 can be performed in serial and/or in parallel. Method 100 can be performed in real-time or near real-time. In one instance, method 100 steps 130-152 can be performed continuously for each comment associated with the recipe. In one embodiment, the comment sentiment can be evaluated prior to natural language processing of the comment to minimize processing time. That is, only comments with positive or neutral sentiments can be processed, eliminating the need to process comments with negative sentiments. In one instance, method 100 steps 132-150 can be performed for each suggested extracted from the comment. For example, if a comment includes three suggestions for improving a recipe, the steps 132-150 can be performed three times, once for each suggestion.

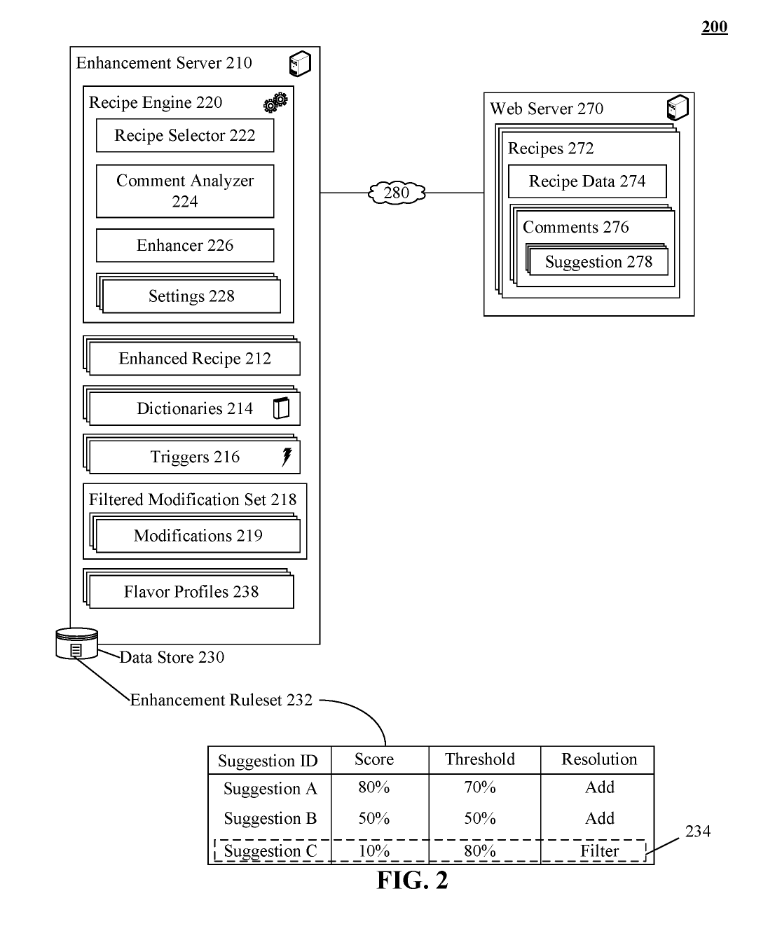

FIG. 2 is a schematic diagram illustrating a system 200 for automatically modifying a food preparation recipe based on user generated suggestions in accordance with an embodiment of the inventive arrangements disclosed herein. System 200 can be performed in the context of method 100.

Enhancement server 210 can be a hardware/software entity for executing recipe engine 220. Server 210 can include, but is not limited to, recipe engine 220, enhanced recipe 212, dictionaries 214, triggers 216, filtered modification 218, data store 230, and the like. Server 210 functionality can include, but is not limited to, load balancing, file sharing, encryption, user authentication, and the like. In one instance, server 210 can be a component of a distributed network environment, a distributed computing environment, and the like. In one embodiment, server 210 functionality can be a component of an artificial intelligence (AI) network.

Recipe engine 220 can be a hardware/software element for automatically generating an enhanced recipe 212 from user generated comments 276 associated with a recipe 272. Engine 220 can include, but is not limited to, recipe selector 222, comment analyzer 224, enhancer 226, settings 228, and the like. In one instance, engine 220 can be a functionality of a question answering (QA) computing system able to perform natural language processing, information retrieval, knowledge representation, automated reasoning, machine learning, and the like. It should be appreciated that engine 220 can be a functionality of any executable environment and is not limited to specific computing hardware/software arrangements. It should be appreciated that engine 220 recipe can be arbitrarily complex and is not limited to the arrangements presented herein.

In one embodiment, engine 220 can be a functionality of a content management system (CMS). In one instance, engine 220 can provide a computer generated “people's choice recipe” (e.g., recipe 212) of a recipe 272 which can be an aggregate of suggestions 278 provided by user provided comments 276. In the instance, enhanced recipe 212 can be presented when a search for a recipe 272 is performed. For example, when a user searches for a lasagna recipe, the “people's choice recipe” version (e.g., enhanced recipe 212) of recipe 272 can be presented. It should be appreciated that enhanced recipe 212 can be presented in a search result with a ranking higher, lower, or equivalent to recipe 272. For example, when a search is performed by a user for “quiche”, an enhanced recipe 212 can be presented above the search listing for quiche recipe 272. In one instance, recipe 212 can be denoted to indicate the recipe is preferred. For example, recipe 212 can include a graphic icon such as a chef's hat to indicate the recipe 212 is a superior recipe to that of recipe 272. It should be appreciated that presentation 212 of recipe can be arbitrarily complex and is not limited to the arrangements presented herein.

Recipe selector 222 can be a hardware/software element for selecting and/or processing a recipe 272. Selector 222 functionality can include, but is not limited to, identifying a recipe with comments, processing one or more recipe components, and the like. In one instance, selector 222 can be utilized to select common recipes (e.g., macaroni and cheese, baked chicken). In the instance, the enhancement of well-known recipes can increase the likelihood that users can find the enhanced recipe when browsing a recipe based Web site. In one embodiment, selector 222 can be utilized to establish a flavor profile 238 for recipe 272. In the embodiment, flavor profile 238 can conform to one or more traditional and/or proprietary flavor profile conventions. For example, the flavor profile of recipe 272 can be quantified in values associated with the five basic flavors. In one instance, flavor profile can include, but is not limited to, a salty flavor, a spice flavor, a bitter flavor, a sour flavor, and a sweet flavor.

Comment analyzer 224 can be a hardware/software entity for determining one or more user provided suggestions within a comment. Analyzer 224 functionality can include, but is not limited to, natural language processing, suggestion detection, suggestion analysis, and the like. In one instance, analyzer 224 can utilize a dictionary to identify keywords which can indicate recipe modifications. In the instance, keywords can include, but is not limited to, measurement units, ingredient names, cooking method names, and the like. In one instance, analyzer can determine a sentiment associated with a suggestion to assess the value of the comment and/or suggestion. In the instance, the suggestion can be evaluated programmatically (e.g., natural language processing) to translate the suggestion into a modification (e.g., 219) which can be utilized to modify the recipe 272. In one embodiment, a filtered modification set 218 can be employed to collect modifications which can be performed to the recipe 272.

Enhancer 226 can be a hardware/software element for improving recipe 272 from suggestions 278 associated with comments 276. Enhancer 226 can functionality can include, but is not limited to, recipe component addition, recipe component removal, recipe component modification, suggestion conflict resolution, and the like. In one embodiment, one or more dictionaries (e.g., cooking databases) can be utilized to ensure modifications align with cooking procedures, acceptable cooking parameters (e.g., minimum/maximum quantities), flavor enhancing practices, flavor balancing practices, and the like. For example, in a modification 219 adds sweetness to recipe 272, engine 220 can add more spice (e.g., black pepper, cayenne) to balance the flavor profile.

It should be appreciated that enhancement ruleset 232 can include one or more thresholds associated with flavor enhancement, flavor balancing, recipe simplification, and the like.

Settings 228 can be one or more rulesets for establishing the behavior of server 210, engine 220, and/or system 200. Settings 228 can include, but is not limited to, recipe selector 222, comment analyzer 224, enhancer 226, settings 228, and the like. In one instance, settings 228 can include, but is not limited to, whitelists, blacklists, and the like. For example, settings 228 can include a cooking method whitelist and an ingredient blacklist to limit cooking method enhancements to baking and broiling and unusual ingredients such as puffer fish (e.g., fugu). It should be appreciated that settings 228 can be manually and/or automatically determined. In one instance, settings 328 can be configured via a computing interface (e.g., communicatively linked to engine 220, server 270).

Enhanced recipe 212 can be an aggregate data set programmatically generated by engine 220. Recipe 212 components can include, but is not limited to, an enhanced recipe name (and e.g., locale or provenance) of the dish, a modified time required for preparation the dish, a modified ingredient list, a modified ingredient quantities, a modified ingredient proportion, a modified necessary equipment and environment for preparation of the dish, a modified ordered list of preparation steps and techniques, the modified yield, the modified texture and/or flavor, a modified photograph of the finished dish, a modified photograph of one or more steps (e.g., associated with ordered list), a modified video, and the like.

Dictionaries 214 can be a data set for programmatically generating enhanced recipe 212. Dictionary 214 can be a resource that lists measurements, ingredients, and the like. In one embodiment dictionary 214 can include multiple dictionaries (e.g., ingredient dictionary, measurement dictionary). In one instance, dictionary 214 can include ingredient equivalencies, ingredient usage, cooking methods, cooking rules, and the like. For example, dictionary can include minimum and/or maximums for cooking time and/or ingredient quantities.

Triggers 216 can be one or more data sets for enabling natural language processing and/or automated processing of comments 276 and/or suggestions 278. In one instance, triggers 216 can include, but is not limited to, trigger keywords, trigger rules, and the like. For example, triggers 216 can include keywords such as “substitute”, “instead of”, “remove”, and “decreased” which can be utilized to indicate a suggestion 278. That is, triggers 216 can be employed to detect a suggestion 278 within comment 276. In one instance, triggers 216 can include cooking method triggers such as cooking type keywords (e.g., fried, sautéed) which can be utilized to trigger suggestion 278 identification and/or processing.

Filtered modification set 218 can be one or more data sets for enabling automated modification of recipe 272 and/or generation of enhanced recipe 212 from user provided suggestions 278. Set 218 can include, but is not limited to, modifications 219, a rule set, and the like. For example, modification set 218 can include three suggested changes to a recipe which had very high ratings on a recipe Web site. In one embodiment, modification 218 can be a structured (e.g., syntactically organized) data set associated with modifying recipe 272 to produce enhanced recipe 212. For example, modification 218 can be an attribute value pair such as “Ingredient=sugar”, “Measurement=cup”, “Amount=¼”, “Ingredient Trigger=add” which can be utilized to modify the recipe 272 programmatically.

Data store 230 can be a hardware/software component able to persist settings 228, ruleset 232, enhanced recipe 212, dictionaries 214, triggers 216, filtered modification set 218, and the like. Data store 230 can be a Storage Area Network (SAN), Network Attached Storage (NAS), and the like. Data store 230 can conform to a relational database management system (RDBMS), object oriented database management system (OODBMS), and the like. Data store 230 can be communicatively linked to server 210 in one or more traditional and/or proprietary mechanisms. In one instance, data store 230 can be a component of Structured Query Language (SQL) complaint database.

Enhancement ruleset 232 can be one or more rules for establishing the behavior of engine 220 and/or engine 220 components. In one instance, ruleset 232 can be utilized to establish user specific rules for filtered modification set 218 creation, enhanced recipe 212 generation, dictionary 214 selection, and the like. For example, a rule 234 of ruleset 232 can permit a suggestion C (e.g., from a comment 276) to be ignored (e.g., not added to set 218) when the score of the suggestion falls below threshold a previously established for adjusting the cooking method of recipe 272. That is, each modification type (e.g., ingredient addition, cooking method, etc.) can be associated with a threshold to enable truly automated and/or rigorous control of recipe 212 generation. In one embodiment, threshold can include a flavor profile threshold which can be utilized to adjust an enhanced recipe 212 flavor profile (e.g., profile within 238) to conform to a previously established flavor profile of the recipe 272 (e.g., profile within 238). For example, when the enhanced recipe 212 is too salty (e.g., exceeds the previously established flavor profile for recipe 272), the engine 220 can balance out the flavor profile by adding a ½ cup of kale. It should be appreciated that engine 220 can modify recipe 212 by adding, removing and/or adjusting quantities of spices, ingredients, sauces, and the like.

Web server 270 can be a hardware/software entity for presenting one or more recipes 272. Server 270 can include, but is not limited to, recipes 272, settings, and the like. In one embodiment, recipes 272 can include, but is not limited to, recipe data 272 comments 276, and the like. In one instance, comments 276 can be associated with one or more suggestions 278. Server 270 functionality can include, but is not limited to, Web hosting, file sharing, user authentication, file serving, and the like.

Recipe 272 can conform to one or more traditional and/or proprietary schemas including, but not limited to, Extensible Markup Language, plain text, comma separated value, and the like. Recipe 272 can include recipe data 274 which can be portion of a database table, a set of database tables, and the like. In one instance, recipe data 274 can include recipe metadata (e.g., creation date, author, modification date), and the like. In one embodiment, recipe 272 can be associated with one or more comments 276 which can include one or more user provided suggestions 278.

Network 280 can be an electrical and/or computer network connecting one or more system 200 components. Network 280 can include, but is not limited to, twisted pair cabling, optical fiber, coaxial cable, and the like. Network 280 can include any combination of wired and/or wireless components. Network 280 topologies can include, but is not limited to, bus, star, mesh, and the like. Network 280 types can include, but is not limited to, Local Area Network (LAN), Wide Area Network (WAN), Virtual Private Network (VPN) and the like.

Drawings presented herein are for illustrative purposes only and should not be construed to limit the invention in any regard. It should be appreciated that one or more components within system 200 can be optional components permitting that the disclosure functionality be retained. It should be understood that engine 220 components can be optional components providing that engine 220 functionality is maintained. It should be appreciated that one or more components of engine 220 can be combined and/or separated based on functionality, usage, and the like. System 200 can conform to a Service Oriented Architecture (SOA), Representational State Transfer (REST) architecture, and the like. In one embodiment, engine 220 can be a functionality of a Web-based Service, an Asynchronous Javascript and Extensible Markup Language (AJAX) functionality, Web application, and the like.

It should be appreciated that data sets of the disclosure can conform to any traditional and/or proprietary data structure including, but not limited to, an array, a multi-dimensional array, a struct, a class, a linked list, a double linked list, a circular linked list, and the like.

The flowchart and block diagrams in the FIGS. 1-2 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of automatically modifying cooking recipes based on user posted suggestions comprising:
detecting, by a computing device, a food preparation recipe, which is manually created by a human, posted on a Web site having at plurality of posted user comments directed to the food preparation recipe;
extracting human constructed suggested recipe modifications from the plurality of posted user comments on the Web site;
for each of the suggested recipe modifications, quantifying a modification score based on analyzed positive and negative sentiments indicated on the Web site for a corresponding one of the suggested recipe modifications;
detecting conflicting suggested recipe modifications;
filtering the suggested recipe modifications to create a filtered modification set, wherein the filtering excludes suggested recipe modifications having a modification score under a designated threshold, and wherein the filtering excludes suggested recipe modifications in conflict and having a lower modification score than other suggested recipe modifications to which the conflict arises;
generating a computer constructed food preparation recipe that applies all of the suggested recipe modifications of the filtered modification set to the food preparation recipe, wherein the computer constructed food preparation recipe was not created by a human but is a novel aggregate from inputs of at least three different humans; and
presenting the computer constructed food preparation recipe on the Web site.
